(19) United States
(12) Patent Application Publication
(10) Pub. No.: US 2011/0072004 A1
(43) Pub. Date: Mar. 24, 2011

(54) EFFICIENT XPATH QUERY PROCESSING

(75) Inventor: Primo M. Pettovello, Canton, MI (US)

(73) Assignee: INTERNATIONAL BUSINESS MACHINES CORPORATION, Armonk, NY (US)

(21) Appl. No.: 12/565,865

(22) Filed: Sep. 24, 2009

(51) Int. Cl. G06F 17/30; G06F 7/00

(52) U.S. Cl. 707/715; 707/E17.008; 707/E17.014; 707/E17.044; 707/E17.123

(57) ABSTRACT

A system, method and program product for processing an inputted XPath query against an XML document. A method is disclose that includes: generating a path index and an MTree structure index from the XML document using a computing device, wherein the MTree structure index has at least one qpath; executing a query against the path index to generate an initial sequence containing a node for each qpath in the XML document that satisfies the query; generating a hash map from the initial sequence from an MTree structure index containing path ids that are located along qpaths in a second MTree structure index; and testing the path id of each node located along a qpath of the Mtree structure index against the path id in the hash map to generate a result sequence.

### FIELD OF THE INVENTION

This disclosure is related to a system and method for processing XPath queries, and more particularly to a system, method and program product that optimizes MTree indexing in XPath querying.

### BACKGROUND OF THE INVENTION

XQuery is a query language that is designed to query collections of XML data. It is semantically similar to SQL. XQuery provides the means to extract and manipulate data from XML documents or any data source that can be viewed as XML, such as relational databases or office documents. XQuery uses XPath expression syntax to address specific parts of an XML document. It supplements this with a SQL-like “FLWOR expression” for performing joins. A FLWOR expression is constructed from the five clauses after which it is named: FOR, LET, WHERE, ORDER BY, RETURN. XPath (XML Path Language) is a language for selecting nodes from an XML document.

Although commercial database systems provide capabilities to process XPath, they are largely optimized for rapid processing of ancestor/descendant and value based queries, yet it has been shown that structure navigation in these systems is still relatively slow and can be improved upon. Because performance of the state of the art XML aware database systems has yet to provide such capabilities, an XML index that performs better than existing implementations is needed, without using a schema and without manual definition of path indexes. Also needed is an XML index that can also efficiently support structure inserts and updates while still supporting the first design goal.

### MTree Overview

An XML document logically is an ordered, vertex-labeled, tree where the vertices are called elements. Each element can contain associated character data and each element can have zero or more uniquely labeled attributes. A well formed XML document contains one or more elements nested properly within each other and contains exactly one root element. An XML document has an ordering property that is defined by a preorder traversal of the document elements which is achieved by sequentially reading the document. The term qname, i.e., qualified-name, is used to refer to an element name (node label) or to an attribute name.

An XPath query is a hierarchical query, that contains multiple location steps separated by one or more “/” or “//” symbols. A location step is comprised of an axis, followed by a name test and then one or more predicate tests delimited with square braces “[ ]”. The “/” implies the default child axis and “//” effectively implies the descendant axis. A predicate returns a true or a false when evaluated. An example XPath query may appear as: /a/b[h/k].

The index “MTree”, also known as “MTree structure index”, is a composite of several digraphs, including four core digraphs, denoted X-digraph, on the set of nodes comprising an XML document. Each XML node (vertex) maintains several unique outbound directed arcs and each arc is part of a separate digraph. The four core sets of arcs are directly associated with the corresponding XPath axes: (1) the set of first following arcs comprise the f-digraph, (2) the set of first preceding arcs comprise the p-digraph, (3) the set of first ancestor arcs comprise the a-digraph, and (4) the set of first descendant arcs comprise the d-digraph. Therefore, the core navigational graph MTree is formed from the composite overlay of f-digraph, p-digraph, a-digraph and d-digraph. The remaining XPath axes are derived from algebra on the primary axes digraphs. Furthermore, each node maintains references for the previous and next node having the same qualified name (qname, label). The qname references are doubly linked in DFS order and called “qpaths”, where the complete set of qpaths form the q-digraph. Each element node also maintains a reference to the first attribute node when one exists; and in a similar fashion the attribute nodes are also doubly linked, forming the attr-digraph.

XPath queries are solved by iterating search traversals on MTree axes paths, typically in document order, using various algorithms. An axis path, denoted XPath, forms a sequence of subtree root nodes, in document order, within an X-digraph, relative to some context node c. When an XPath is traversed from a context node to the end of the axis path, all of the nodes contained under the sequence of subtree root nodes along the path belong to the requested axis.

Further prior art descriptions of MTree structures and processing are disclosed, e.g., in US 2006/0064432, US 2007/0112803, and US 2007/0174309 the contents of which are incorporated by reference.

### SUMMARY OF THE INVENTION

Disclosed are improved XPath query processing algorithms on schema-less XML documents by extending an existing MTree navigational XML database index. The algorithms may be implemented as a system, method or program product. The improvement involves the creation of a supplementary index, called “MTpath index” or “MTpath” that is used as a qpath pre-processor for an existing MTree index. The MTpath index is itself an MTree structure index.

In a first aspect, the invention provides An XPath query processing system for processing an inputted query against an XML document, comprising: a computer system that includes: an index creation system that generates an MTpath index and an MTree structure index from the XML document, wherein the MTpath index and the MTree structure index each have at least one qpath and are linked together by at least one named qlink originating from the MTpath index that is connected to a starting node in a qpath in the MTree structure index; and a query execution system that includes: a system for executing a query against the MTpath index to generate an initial sequence containing the starting node for each applicable qpath in the MTree structure index that satisfies the query; a system for generating a hash map containing path ids from the initial sequence from an MTpath index; and a system for testing the path id of each node located when traversing a qpath of the MTree structure index against the path id in the hash map to generate a result sequence.

In a second aspect, the invention provides a method for processing an inputted XPath query against an XML document, comprising: generating an MTpath index and an MTree structure index from the XML document, wherein the MTpath index and the MTree structure index each have at least one qpath and are linked together by named qlinks originating from the MTPath index to the MTree structure index; executing a query against the MTpath index to generate an initial sequence containing the starting node for each applicable qpath in the MTree structure index that satisfies the query; generating a hash map containing path ids from the initial sequence from an MTpath index; and testing the path id of each node located when traversing a qpath of the MTree structure index against the path id in the hash map to generate a result sequence.

In a third aspect, the invention provides a computer readable medium having a computer product for processing an inputted XPath query against an XML document, which when executed by a computing device, comprises: program code that generates an MTpath index and an MTree structure index from the XML document, wherein the MTpath index and the MTree structure index each have at least one qpath and are linked together by named qlinks originating from the MTPath index to the MTree structure index; program code that executes a query against the MTpath index to generate an initial sequence containing the starting node for each applicable qpath in the MTree structure index that satisfies the query; program code that generates a hash map containing path ids from the initial sequence from an MTpath index; and program code that tests the path id of each node located when traversing a qpath of the MTree structure index against the path id in the hash map to generate a result sequence.

In a fourth aspect, the invention provides a method for deploying a system for processing an inputted XPath query against an XML document, comprising: providing a computer infrastructure being operable to: generate an MTpath index and an MTree structure index from the XML document, wherein the MTpath index and the MTree structure index each have at least one qpath and are linked together by named qlinks originating from the MTPath index to the MTree structure index; execute a query against the MTpath index to generate an initial sequence containing the starting node for each applicable qpath in the MTree structure index that satisfies the query; generate a hash map containing path ids from the initial sequence from an MTpath index; and test the path id of each node located when traversing a qpath of the MTree structure index against the path id in the hash map to generate a result sequence.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having an XPath processing system in accordance with an embodiment of the present invention.

FIG. 2 depicts an MTree structure index in accordance with an embodiment of the present invention.

FIG. 3 depicts a MTpath index in accordance with an embodiment of the present invention.

FIG. 4 depicts physical MTpath index in accordance with an embodiment of the present invention.

FIG. 5 depicts the qlink mapping between an MTpath index and an MTree structure index linking the qpath starting positions in accordance with an embodiment of the present invention.

FIG. 6 depicts a flow diagram of a method in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

### MTree Optimization

Described herein are enhancements to the MTree concept. The solution is a combination of several components, including data structures and algorithms, which improve the way an MTree structure index is accessed. Essentially, MTpath is an MTree structure index which indexes the starting locations of qpaths located in another MTree structure index.

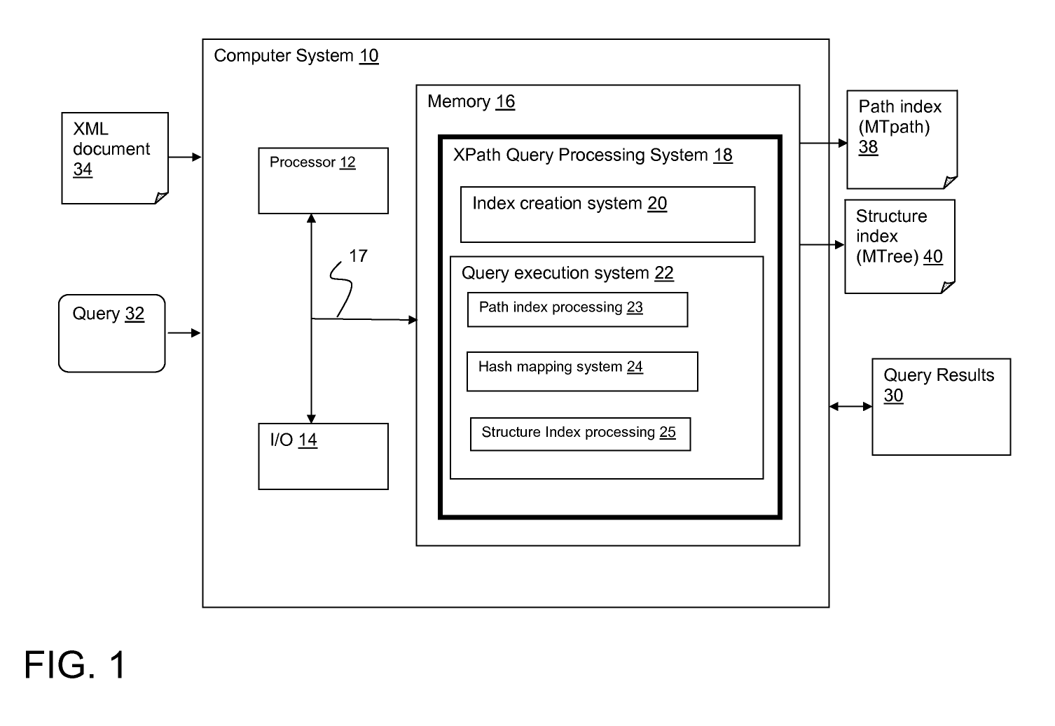

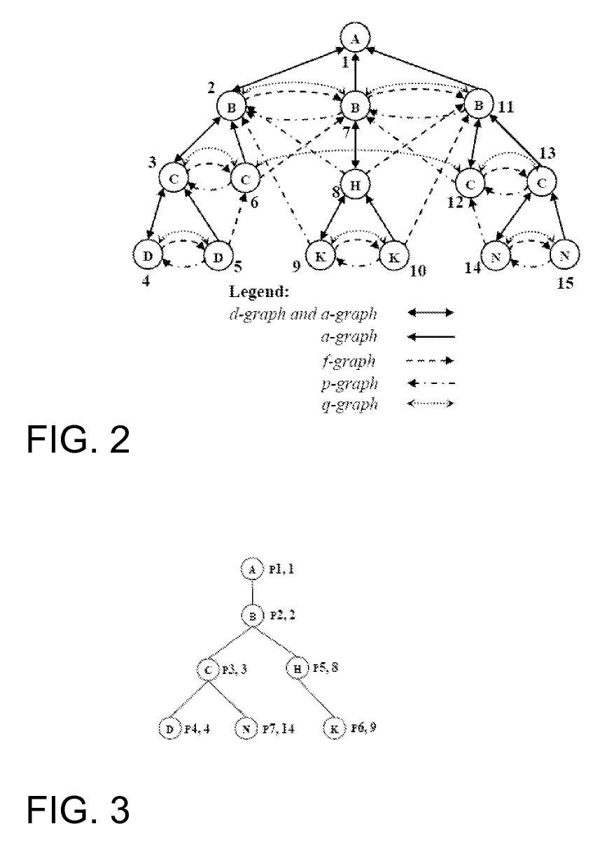

FIG. 1 depicts a computer system 10 having an XPath query processing system 18 for generating query results 30 for an inputted query 32 against an XML document 34. Included in query processing system 18 are an index creation system 20 that creates a qpath index MTPath 38 and an MTree structure index 40; a query execution system 22 and a hash mapping system 24. The MTpath index 38 is itself an XML document indexed as an MTree that contains one node for every unique path. Thus, the MTpath index is a substantial summarization of the MTree structure index and of the whole XML document 34.

Each node in the MTpath index is connected to the MTree structure index by a “Oink”. A qlink is a named pointer from a node along a qpath in the MTpath index to the first node along a qpath in the MTree structure index, each having the same qname.

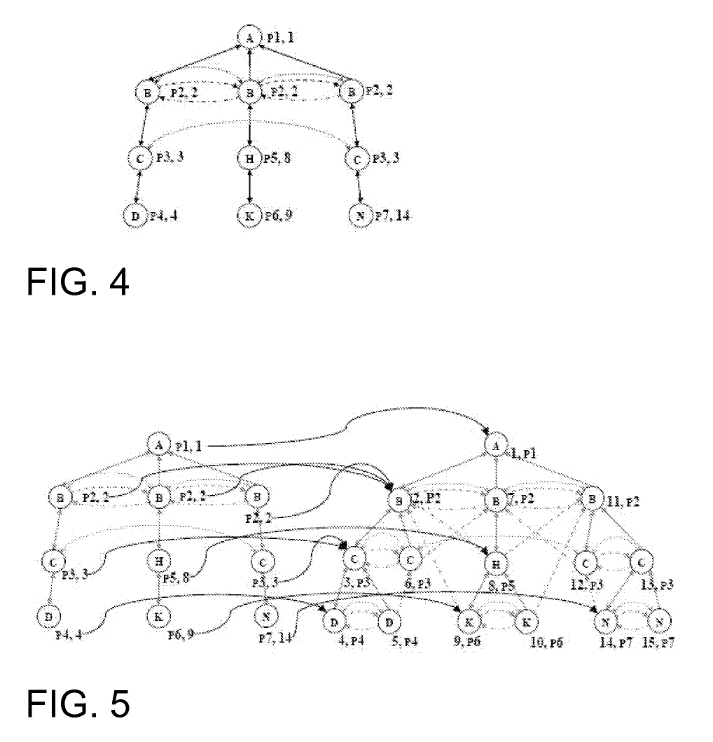

An MTpath index 38 is a summary XML structure that has one node for each unique node label, for each unique root to node path, from the incoming XML document 34. FIG. 3 depicts an example of an MTpath index. Each node in the MTpath index has the attributes qnameID, pathID and firstNode. The logical MTpath index for FIG. 3 is shown in FIG. 4. In FIG. 4, each node is annotated with a pathID, e.g., p1, p2 . . . etc., and the first node reference for each label (1, 2, 3 . . . etc.) in the MTree.

The MTpath index maintains one unique identifier, pathlD, for each uniquely labeled root-to-node path. Each node in the MTpath index has the attributes qnameID, pathID and firstNode. The pathID is added to each corresponding MTree structure node having the same root-to-leaf path. A separate entry is created for both element nodes and for attribute nodes. The creation of MTpath index 38 is integrated with the index creation system 20 (i.e., MTree build process) and also reuses the existing MTree SAX event streaming build process. Index creation system 20 provides a physical MTpath index, which is different than the logical MTpath index, an example of which is shown in FIG. 4. Each node in FIG. 4 is likewise annotated with the pathID and the first node reference for each label.

The MTpath index can be redundant with element names, but the root-to-leaf paths are unique. If an element name appears in more than one root-to-leaf path, then the element name will appear in multiple MTpath summaries, once for each unique path.

The redundancy can be observed in FIG. 4 with the redundant B and C nodes. For example, the redundant C nodes exist to support the D node for path p4 and the N node for path p7. The node redundancy exists because of the way new paths are sequentially written to disk when encountered. Path identifiers are calculated in such a way as to support single pass efficiency by using only the localized stack information. No attempt is made to find the same pathID located in a different segment of the MTpath index and there is no attempt to update paths that are no longer available in the current stack. In the example shown in FIG. 4, the node redundancy appears prevalent, but in practice, with larger documents that have many repeating paths this situation will be less of an issue. The MTpath index is itself an MTree index, but the following and preceding linkages are not meaningful in this context and are therefore largely ignored and not shown in FIG. 4.

To ensure uniqueness while quickly calculating the pathID, an array of unique ascending prime numbers is used for the calculation. The level number of the element node becomes the offset into the prime number array. The pathID is constructed by summing the multiplication of the key of the nodes label by the prime number located at the nodes level. This method ensures uniqueness when nodes having the same label appear in different levels. To differentiate between attributes and elements having the same label at the same level the “@” symbol is inserted into the path just before the attribute label key is used. Equation 1 shows the calculation of path ID, where n is the stack depth, p is the prime number array, and k is the key for the node label a level i. Equation 2 shows the calculation of path ID, when the path includes an attribute, where n is the stack depth, p is the prime number array, k is the key for the node label at level i, ord(“@”) is the numeric ordinal of the “at” symbol, and ka is the key to the attribute label.

pathID=Σᵢ₌₀ⁿpᵢ·kᵢ (1)

pathID=Σᵢ₌₀ⁿpᵢ·kᵢ+ord(“@”)·pₙ₊₁+pₙ₊₂·ka (2)

Referring again to FIG. 1, query execution system 22 processes query 32 by first executing query 32 against the MTpath index 38. The result is the first node in an applicable qpath. Using the present optimization, queries are processed in two steps including: (1) MTpath index processing 23; and (2) MTree structure index processing 25. When using the MTpath index 38, query execution system 22 optimizes the process by first issuing the ancestor-descendant structure only portion of an XPath query against MTpath index 38 (MTpath index processing 23) and to subsequently execute the remaining parts of the query using the full MTree structure (structure index processing 25).

When a query 32 is issued against MTpath index 38, an initial sequence is returned. The initial sequence is compressed into a hash map using pathID by hash mapping system 24 For example, suppose the query //B is issued against MTpath index 38 in FIG. 4. This query will result in a sequence of three B nodes, which will be hashed into a map based on pathID. Since each node resides on the same named path, the result in the hash map will be a single entry with a pathID value of p2 with a starting location in the structure index, firstNode=2. FIG. 5 depicts a resulting hash map in which pathIDs are mapped between the MTpath index and MTree structure index. The pathID hash map will be used for a hash join when traversing the B qpath. Thus, the qualified name redundancy in the MTpath index is not carried forward to the query execution in the structure index, but it is eliminated when building the hash map.

The result of a query against the MTpath index 38 is the starting position of one or more nodes on the applicable qpath. There is one node returned for each unique path that correctly satisfies the query. The path ids associated with each of the nodes is hashed into a map. The pathID value for each node on the qpath is tested against the hash map, essentially performing a hash join, to determine if the node should be included in a result sequence. The result sequence is then used to generate query results.

The MTpath index 38 provides higher fidelity over qpath in that it can easily differentiate recursive qnames. When the XML document 34 is qname contiguous the qpath provides essentially the same structure information as would doubly-linking the pathID through MTree 40. When the document is non-contiguous then pathID provides equal to or better selectivity.

Combining the MTpath index 38 with the MTree structure index 40 provides substantial query efficiency improvements for the ancestor-descendant structure portions of query. An example combined index is shown in FIG. 5. On the left hand side of FIG. 5 is the MTpath index annotated with pathID and DFS preorder number of structure index first node. On the right hand side is MTree annotated with DFS preorder number and pathID.

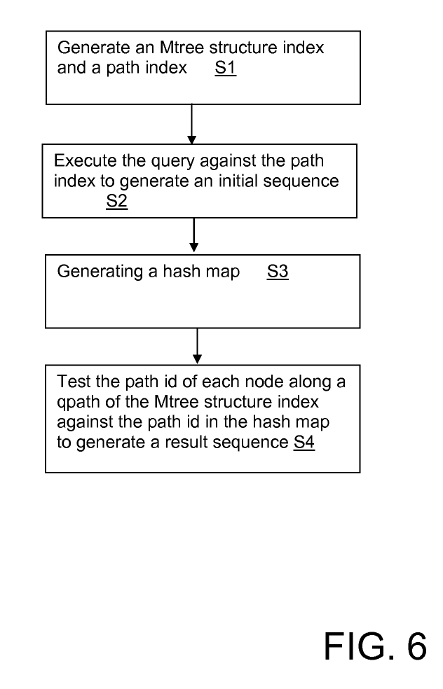

FIG. 6 depicts a flow diagram showing a method of performing an illustrative embodiment of the present invention. At S1, an MTree structure index and a MTpath index are generated from an XML document. At S2, a query is executed against the MTpath index to generate an initial sequence containing a node for each qpath in the XML document that satisfies the query. At S3, a hash map is generated from the initial sequence from an MTree structure index containing path ids that are located along qpaths in a second MTree structure index. At S4, the path id of each node along a qpath of the MTree structure index is tested against the path id in the hash map to generate a result sequence.

Referring again to FIG. 1, it is understood that computer system 10 may be implemented as any type of computing infrastructure/device. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10.

Access to computer system 10 may be provided over a network such as the Internet, a local area network (LAN), a wide area network (WAN), a virtual private network (VPN), etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising an XPath query processing system 18 could be created, maintained and/or deployed by a service provider that offers the functions described herein for customers. That is, a service provider could offer to deploy or provide the ability to provide XPath query processing as described above.

It is understood that in addition to being implemented as a system and method, the features may be provided as a program product stored on a computer-readable medium, which when executed, enables computer system 10 to provide an XPath query processing system 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. An XPath query processing system for processing an inputted query against an XML document, comprising:
a computer system that includes:
an index creation system that generates an MTpath index and an MTree structure index from the XML document, wherein the MTpath index and the MTree structure index each have at least one qpath and are linked together by at least one named qlink originating from the MTpath index that is connected to a starting node in a qpath in the MTree structure index; and
a query execution system that includes:
a system for executing a query against the MTpath index to generate an initial sequence containing the starting node for each applicable qpath in the MTree structure index that satisfies the query;
a system for generating a hash map containing path ids from the initial sequence from an MTpath index; and
a system for testing the path id of each node located when traversing a qpath of the MTree structure index against the path id in the hash map to generate a result sequence.

2. The XPath query processing system of claim 1, wherein the result sequence comprises a first node of each applicable qpath.

3. The XPath query processing system of claim 2, wherein the system for executing the query traverses the each applicable qpath from an associated first node.

4. The XPath query processing system of claim 1, further comprising a system for executing the query against the result sequence to traverse each applicable qpath only one time.

5. The XPath query processing system of claim 1, wherein the path id is calculated using an array of unique ascending prime numbers.

6. The XPath query processing system of claim 1, wherein the path index maintains one path id for each uniquely labeled root-to-node path in the XML document.

7. The XPath query processing system of claim 1, wherein the system for testing the path id of each node uses a hash join to determined if a node should be included in the result sequence.

8. A method for processing an inputted XPath query against an XML document, comprising:
generating an MTpath index and an MTree structure index from the XML document, wherein the MTpath index and the MTree structure index each have at least one qpath and are linked together by named qlinks originating from the MTPath index to the MTree structure index;
executing a query against the MTpath index to generate an initial sequence containing the starting node for each applicable qpath in the MTree structure index that satisfies the query;
generating a hash map from the initial sequence from an MTree structure index containing path ids that are located by traversing qpaths in a second MTree structure index; and
testing the path id of each node located when traversing a qpath of the MTree structure index against the path id in the hash map to generate a result sequence.

9. The method of claim 8, wherein the result sequence comprises a first node of each applicable qpath.

10. The method of claim 9, wherein executing the query traverses the each applicable qpath from an associated first node.

11. The method of claim 8, further comprising executing the query against the result sequence to traverse each applicable qpath only one time.

12. The method of claim 8, wherein the path id is calculated using an array of unique ascending prime numbers.

13. The method of claim 8, wherein the path index maintains one path id for each uniquely labeled root-to-node path in the XML document.

14. The method of claim 8, wherein testing the path id of each node uses a hash join to determined if a node should be included in the result sequence.

15. A computer readable medium having a computer product for processing an inputted XPath query against an XML document, which when executed by a computing device, comprises:
program code that generates an MTpath index and an MTree structure index from the XML document, wherein the MTpath index and the MTree structure index each have at least one qpath and are linked together by at least one named qlink originating from the MTpath index that is connected to a starting node in a qpath in the MTree structure index;
program code that executes a query against the MTpath index to generate an initial sequence containing the starting node for each applicable qpath in the MTree structure index that satisfies the query;
program code that generates a hash map containing path ids from the initial sequence from an MTpath index; and
program code that tests the path id of each node located when traversing a qpath of the MTree structure index against the path id in the hash map to generate a result sequence.

16. The computer readable medium of claim 15, wherein the result sequence comprises a first node of each applicable qpath.

17. The computer readable medium of claim 16, wherein the program code that executes the query traverses the each applicable qpath from an associated first node.

18. The computer readable medium of claim 15, further comprising program code that executes the query against the result sequence to traverse each applicable qpath only one time.

19. The computer readable medium of claim 15, wherein the path id is calculated using an array of unique ascending prime numbers.

20. The computer readable medium of claim 15, wherein the path index maintains one path id for each uniquely labeled root-to-node path in the XML document.

21. The computer readable medium of claim 15, wherein the program code that tests the path id of each node uses a hash join to determined if a node should be included in the result sequence.

22. A method for deploying a system for processing an inputted XPath query against an XML document, comprising:
providing a computer infrastructure being operable to:
generate an MTpath index and an MTree structure index from the XML document, wherein the MTpath index and the MTree structure index each have at least one qpath and are linked together by named qlinks originating from the MTPath index to the MTree structure index;
execute a query against the MTpath index to generate an initial sequence containing the starting node for each applicable qpath in the MTree structure index that satisfies the query;
generate a hash map from the initial sequence from an MTree structure index containing path ids that are located by traversing qpaths in a second MTree structure index; and
test the path id of each node located when traversing a qpath of the MTree structure index against the path id in the hash map to generate a result sequence.
